(19) United States
(12) Patent Application Publication
(10) Pub. No.: US 2001/0023784 A1
(43) Pub. Date: Sep. 27, 2001

(54) Position pointing device and a method of customizing finger-touch-portion thereof

(76) Inventor: Yoji Wakui, Saitama-ken (JP)

Correspondence Address: Finnegan, Henderson, Farabow,, Garrett & Dunner, L.L.P., 1300 I Street, N.W., Washington, DC, 20005-3315, US

(21) Appl. No.: 09/777,880

(22) Filed: Feb. 7, 2001

(30) Foreign Application Priority Data
Feb. 7, 2000 (JP) 2000-028775

(51) Int. Cl. G09G 5/00; G06K 11/18

(52) U.S. Cl. 178/19.01; 345/179

(57) ABSTRACT

This invention provides a position pointing device that includes an electronic stylus and includes a transformable portion including a shape-memory resin that can be transformed to fit a user's need or preference even after being completed. In certain embodiments, a dummy stylus may be utilized when transforming the transformable portion. In other embodiments, the transformable portion may have a length to cover a part of or, in the alternative, the whole of a main body of the electronic stylus.

### FIELD OF THE INVENTION

This invention relates to a position pointing device for use with a digitizer or other computer coordinate input system. More particularly, this invention relates to a position pointing device equipped with a finger-touch-portion (a portion touched by fingers) made of a shape-memory resin that can be customized to suit a user's preference even after being completed.

### BACKGROUND OF THE INVENTION

It is desirable that a position pointing device such as an electronic stylus or an electronic cursor be easy for an operator to operate because it is generally used for many hours. However, with respect to a conventional electronic stylus or an electronic cursor, once it is manufactured, its outward appearance cannot be transformed for the purpose of suiting a need or preference of each individual user.

### SUMMARY OF THE INVENTION

The inventor of the present invention found it desirable that a position pointing device product that has left a manufacturer and has been provided to a user should be equipped with a structural component made of a shape-memory resin, such as a thermoplastic resin, capable of being customized to suit a need or preference of the user. Generally, in order to customize a thermoplastic resin, it must be heated by, for example, being placed into hot water. However, a position pointing device is an be placed into water. Specifically, putting a main body of the electronic device into hot water causes the quality of the device to be reduced and/or degraded.

The purpose of this invention is to provide users with a position pointing device that includes a finger-touch-portion comprised of a thermoplastic resin that is capable of being transformed to suit individual preferences or needs of users without putting the main body of the device into water.

A shape-memory resin comprises the portion touched by a user's fingers (the finger-touch-portion) when the electronic stylus or cursor is held by the user. The shape-memory resin and the electronic stylus may be separated from each other by providing a connecting portion to form a junction therebetween. Thus, the shape-memory resin can be transformed without effecting the quality of the main body of the device, by transforming the shape-memory resin of the finger-touch-portion when separated from the electronic stylus. In one embodiment, the finger-touch-portion includes an inner part not to be transformed and an outer part to be transformed. Here, the outer part to be transformed comprises the shape-memory resin. In another embodiment, a dummy stylus that has the same shape as the main body of the device is provided. The dummy stylus may be pointed like a true electronic stylus.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description serve to explain the principles of the invention.

### BRIEF DESCRIPTION OF THE DRAWINGS

FIG. 1A is a perspective view of a finger-touch-portion of a position pointing device of one embodiment of the present invention that comprises a shorter inner portion not to be transformed and an outer portion to be transformed;

FIG. 1B is a perspective view of a position pointing device including a main body of an electronic stylus provided with the finger-touch-portion shown in FIG. 1A;

FIG. 2A is a perspective view of a finger-touch-portion of a position pointing device of another embodiment of the present invention that comprises a longer inner portion not to be transformed and an outer portion to be transformed;

FIG. 2B is a perspective view of a position pointing device including a main body of an electronic stylus provided with the finger-touch-portion shown in FIG. 2A;

FIG. 3A is a perspective view of a finger-touch-portion of a position pointing device of another embodiment of the present invention comprising a transformable portion that is attached to a dummy stylus during its transformation;

FIG. 3B is a perspective view of a position pointing device including a main body of an electronic stylus provided with the finger-touch-portion shown in FIG. 3A;

FIG. 3C is a side view of the position pointing device shown in FIG. 3B;

FIG. 4A is a perspective view of a finger-touch-portion of a position pointing device of another embodiment of the present invention comprising a transformable portion that is attached to a dummy stylus during its transformation, wherein a tip of a dummy stylus is pointed like a true electronic stylus;

FIG. 4B is a perspective view of a position pointing device including a main body of an electronic stylus provided with the finger-touch-portion shown in FIG. 4A;

FIG. 5A is a perspective view of a finger-touch-portion of a position pointing device of another embodiment of the present invention comprising a transformable portion that is attached to a dummy stylus during its transformation, wherein the transformable portion has a length to reach the end of an electronic stylus;

FIG. 5B is a perspective view of a position pointing device including a main body of an electronic stylus provided with the finger-touch-portion shown in FIG. 5A;

FIG. 6A is a perspective view of a finger-touch-portion of a position pointing device of another embodiment of the present invention comprising a transformable portion that is attached to a dummy stylus during its transformation, wherein a tip of the dummy stylus is pointed like a true stylus and wherein the transformable portion has a length to reach the end of a main body of an electronic stylus; and

FIG. 6B is a perspective view of a position pointing device including a main body of an electronic stylus provided with the finger-touch-portion shown in FIG. 6A; and

FIG. 7 is a perspective view illustrating the main body of a true electronic stylus.

### DESCRIPTION OF THE EMBODIMENTS

Reference will now be made in detail to the present embodiments of the invention, examples of which are illustrated in the accompanying drawings.

A shape-memory resin has the characteristics of being easily transformed when heated in hot water up to higher temperatures of a certain degree and being coagulated with its transformed shape maintained when cooled down to lower temperatures. In order for the shape to be transformed, a position pointing device or a transformable portion thereof, which includes the shape-memory resin, is heated in hot water of a high temperature (about 80 degrees Celsius) for about two minutes in order to soften the shape-memory resin.

The softened shape-memory resin is then transformed to suit a need or preference of a user, for example, by the user holding the transformable portion with his or her fingers. The transformed shape-memory resin is then cooled, for example, in water. The cooled shape-memory resin is thus coagulated in the transformed shape and maintains its transformed shape after it cools down.

This invention will now be described with respect to each embodiment thereof, accompanied by certain illustrations.

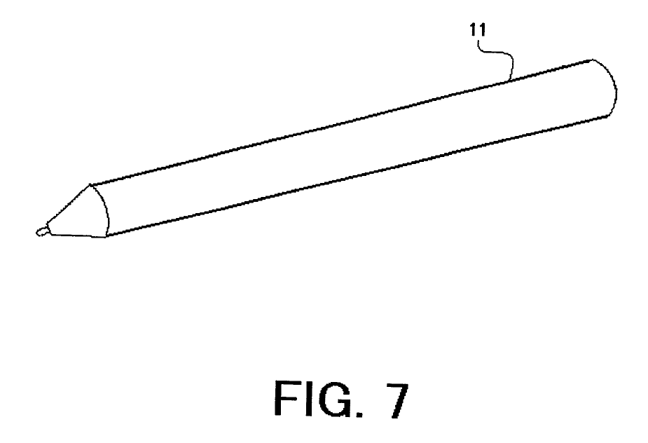

FIG. 7 illustrates an example of a main body of electronic stylus 11 that is utilized as a component of a position pointing device of all of the embodiments of the present invention.

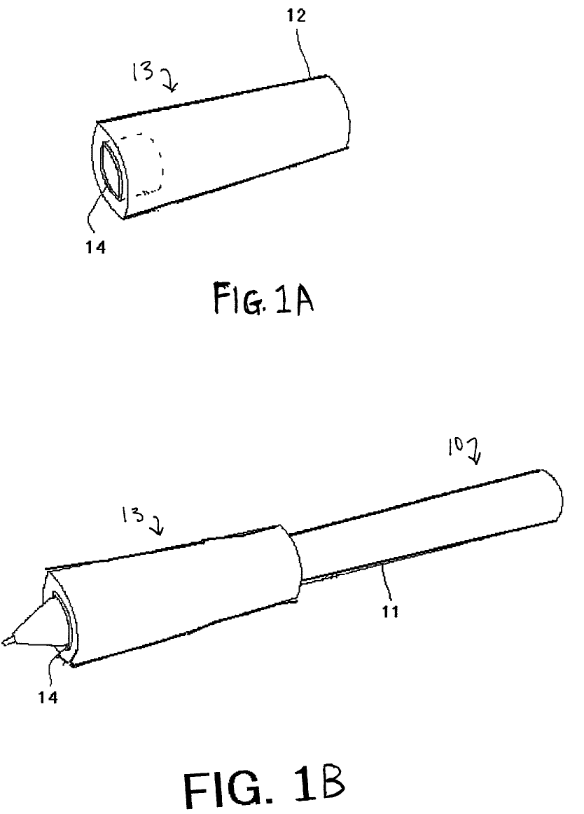

FIGS. 1A and 1B illustrate one embodiment of a position pointing device of the present invention. As shown in FIG. 1B, the position pointing device 10 includes a main body 11, such as of an electronic stylus, and a finger-touch-portion 13. FIG. 1A illustrates the finger-touch-portion 13 of this embodiment before it is transformed and before it is provided on the main body of the electronic stylus 11. The finger-touch-portion 13 comprises an inner part not to be transformed and an outer part to be transformed. As shown in FIG. 1A, the inner part not to be transformed is a connecting portion 14, while the outer part to be transformed is a transformable portion 12. The connecting portion 14 comprises a metal or an ordinary resin that does not have plasticity even when heated. The transformable portion 12 comprises a shape-memory resin. As shown in FIG. 1B, after being transformed, the finger-touch-portion 13 is provided on the main body of the electronic stylus 11.

In order to transform the transformable portion 12 of the finger-touch-portion 13, the entire finger-touch-portion 13, which includes the connecting portion 14 and the transformable portion 12, is immersed in hot water of a high temperature (about 80 degrees Celsius) for about two minutes. After the shape-memory resin of the transformable portion 12 is softened in hot water, the finger-touch portion 13 is taken out from hot water. The finger-touch-portion 13 is then dried. The shape-memory resin of the transformable portion 12 of the finger-touch-portion 13 is then transformed, for example, by the user holding the transformable portion with his or her fingers, before the temperature of the shape-memory resin falls. Then, the transformed transformable portion 12 is cooled, for example, by being immersed in cool water together with the connecting portion 14, until the transformed transformable portion 12 is hardened. The finger-touch-portion 13 including the transformed transformable portion 12 and the connecting portion 14 is then provided on the main body of the electronic stylus 11.

It is desirable that there exists a structure for connecting the connecting portion 14 of the finger-touch-portion 13 and the main body of the electronic stylus 11. By means of this structure for connecting, the finger-touch-portion 13 may be attached to the main body of the electronic stylus 11 and fixed on it. According to the embodiment shown in FIGS. 1A and 1B, the connecting portion 14 is shorter than the transformable portion 12. In certain embodiments, as shown in FIG. 1A, the transformable portion 12 does not include therein an opening or hollow (i.e., a bore) large enough to accommodate the main body of the electronic stylus 11. In these instances, it is generally necessary to make a sufficiently sized hollow inside the transformable portion 12 during a transforming operation.

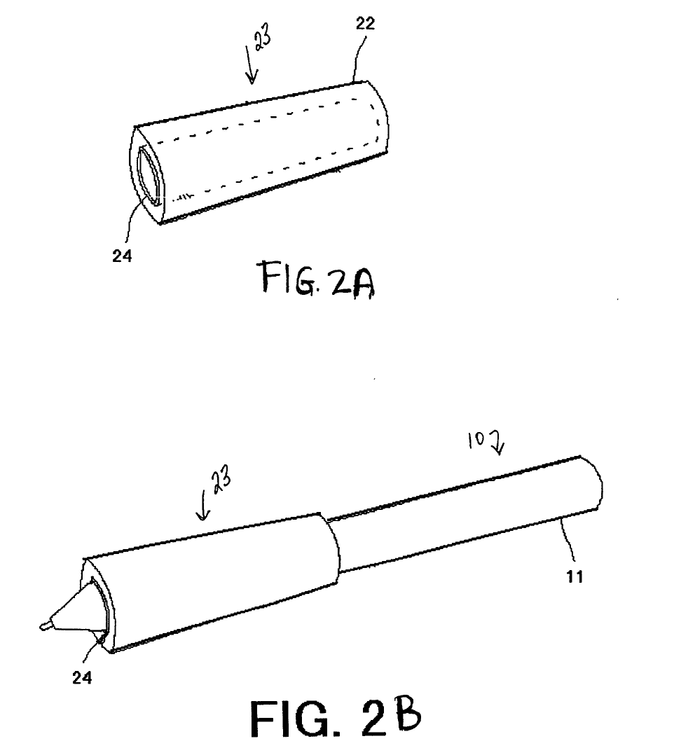

FIGS. 2A and 2B illustrate another embodiment of the position pointing device of the present invention. As shown in FIG. 2B, the position pointing device 10 includes a main body of an electronic stylus 11 and a finger-touch-portion 23. FIG. 2A illustrates the finger-touch-portion 23 of this embodiment before it is transformed and before it is provided on the main body of the electronic stylus 11. In this embodiment, the finger-touch-portion 23 comprises a longer inner portion not to be transformed (a connecting portion 24), as compared to the embodiment shown in FIGS. 1A and 1B, and an outer portion to be transformed (a transformable portion 22). In fact, the finger-touch-portion 23 of this embodiment includes a connecting portion 24 that is as long as the transformable portion 22. Accordingly, in this embodiment, the connecting portion 24 includes a hollow therein that is large enough to accommodate the main body of the electronic stylus 11. Accordingly, it is generally necessary only to transform the outer part touched by fingers (i.e., the transformable portion 22) during a transforming operation.

In addition, the transformable portion 22, which includes a shape-memory resin, may be transformed as discussed above with respect to the transformable portion 12 of the embodiment shown in FIGS. 1A and 1B.

With respect to the embodiments shown in FIGS. 1A and 1B, and FIGS. 2A and 2B, it is possible to transform the shape-memory resin when fixed to the main body of the electronic stylus. In this case, however, it is desirable that the main body of the electronic stylus should be rendered waterproof before being placed into hot water. One manner of rendering the electronic stylus waterproof is by placing it into a bag that is made of a thin vinyl material. The electronic stylus should be rendered waterproof because its main body includes electronic components inside that may be effected if placed into water.

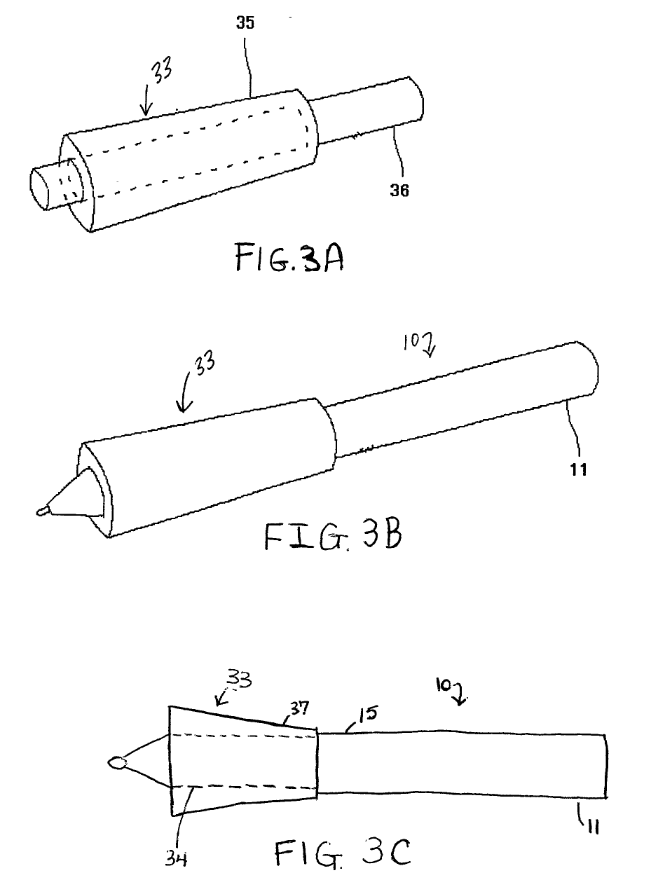

FIGS. 3A through 3C illustrate another embodiment of a position pointing device of the present invention. As shown in FIG. 3B, the position pointing device 10 includes a main body of an electronic stylus 11 and a finger-touch-portion 33. FIG. 3A illustrates the finger-touch-portion 33 of this embodiment before it is transformed and before it is provided on the main body of the electronic stylus 11. In this embodiment, the finger-touch-portion 33 includes only a transformable portion 35. As also shown in FIG. 3A, a dummy stylus 36 is utilized. In particular, the transformable portion 35 is transformed when provided on the dummy stylus 36 and then is later removed from the dummy stylus 36 and provided on the main body of the electronic stylus 11.

In this embodiment, the dummy stylus 36 has almost the same shape as the main body of the electronic stylus 11. Because the dummy stylus 36 does not include any electronic components therein, it is possible to heat the whole body of the dummy stylus 36 in hot water when the finger-touch-portion 33 is provided on the dummy stylus 1 36. In addition, it is possible to successfully fix the finger-touch-portion 33 on the electronic stylus 11 by taking advantage of the effect that the finger-touch-portion 33 compresses the main body of the electronic stylus 11 when attached thereto because the shape-memory resin contracts when hardened. Thus, it is desirable that the finger-touch-portion 33 is attached to the main body of the electronic stylus 11 before it has cooled down. Additionally, to take advantage of the effect of contraction, the dummy stylus 36 may be made a little thinner than the main body of the electronic stylus 11.

Furthermore, referring to FIG. 3C, in order for the finger-touch-portion 33 to be fixed tightly to the main body of the electronic stylus 11 and to make it difficult to separate the two components, a part 34 equipped with the finger-touch-portion 33 may be made a little thinner compared with the outer part 15 of the main body of the electronic stylus 11. In addition, a portion 37 adjacent to the part 34 equipped with the finger-touch-portion may be made slightly thicker compared with the outer part 15 of the main body of the electronic stylus 11. Accordingly, the finger-touch-portion may be prevented from moving upward or downward relative to the main body of the electronic stylus 11, after being provided on the main body of the electronic stylus 11.

In addition, in order to transform the transformable portion 35, which includes a shape-memory resin, of the finger-touch-portion 33, the entire finger-touch-portion 33, including the transformable portion 35, is immersed in hot water of a high temperature (about 80 degrees Celsius) for about two minutes. After the shape-memory resin of the transformable portion 35 is softened in hot water, the finger-touch portion 33 is taken out from hot water. The finger-touch-portion 33 is then dried. The shape-memory resin of the transformable portion 35 of the finger-touch-portion 33 is then transformed, for example, by the user holding the transformable portion 33 with his or her fingers, before the temperature of the shape-memory resin falls. Then, the transformed transformable portion 35 is cooled, for example, by being immersed in cool water, until the transformed transformable portion 35 is hardened. The finger-touch-portion 33 including the transformed transformable portion 35 is then provided on the main body of the electronic stylus 11.

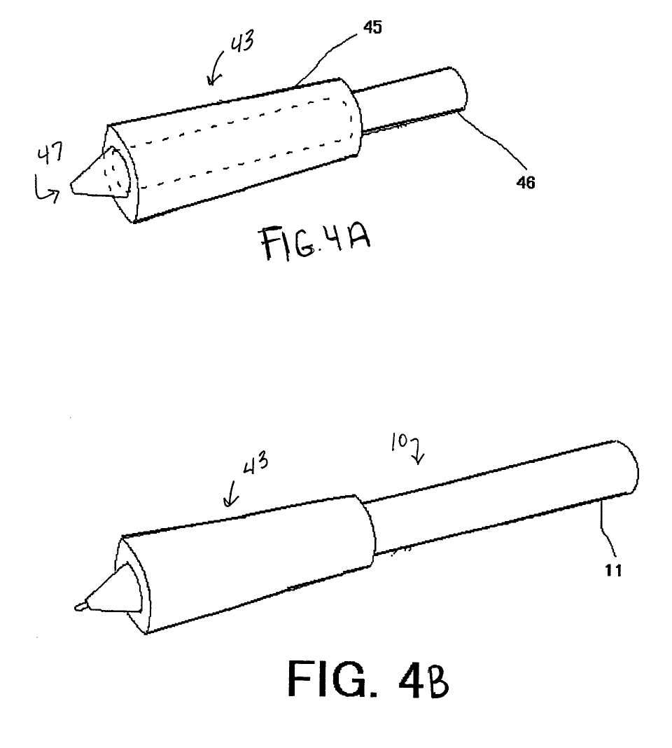

FIGS. 4A and 4B illustrate another embodiment of a position pointing device of the present invention. This embodiment is similar to that shown in FIGS. 3A and 3B, except that a tip 47 of a dummy stylus 46 is made to be pointed. As shown in FIG. 4B, the position pointing device 10 includes a main body of an electronic stylus 11 and a finger-touch-portion 43. FIG. 4A illustrates the finger-touch-portion 43 of this embodiment before it is transformed and before it is provided on the main body of the electronic stylus 11. In this embodiment, the finger-touch-portion 43 includes only a transformable portion 45. As also shown in FIG. 4A, the dummy stylus 46 is utilized. In particular, the transformable portion 45 is transformed when provided on the dummy stylus 46 and then is later removed from the dummy stylus 46 and provided on the main body of the electronic stylus 11.

The advantages of utilizing a dummy stylus are discussed above with respect to the embodiment shown in FIGS. 3A and 3B. In addition, with respect to the embodiment shown in FIGS. 4A and 4B, it is expected that a user can easily make the electronic stylus more comfortable to use by actually trying to write letters with a dummy stylus that has a pointed tip. In other words, after heating the transformable portion 45 of the finger-touch-portion 43 and when transforming the transformable portion 45 when it is provided on the dummy stylus 46, the user may actually try to write letters with the dummy stylus 46 with its pointed tip 47. After the finger-touch-portion 43 is removed from the dummy stylus 46 and provided on the main body of the electronic stylus 11, the transformable portion 45 of the finger-touch-portion 43 maintains its transformed shape that is produced while the user was writing letters utilizing the dummy stylus 46 with its pointed tip 47.

In addition, the transformable portion 45, which includes a shape-memory resin, may be transformed as discussed above with respect to the transformable portion 35 of the embodiment shown in FIGS. 3A and 3B.

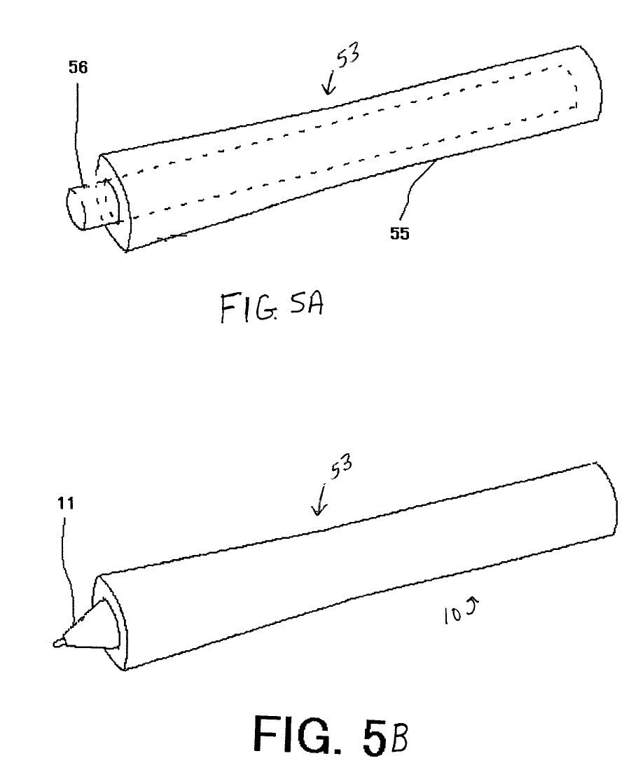

FIGS. 5A and 5B illustrate another embodiment of a position pointing device of the present invention. This embodiment is also similar to that shown in FIGS. 3A and 3B, except that a transformable portion 55 of a finger-touch-portion 53 is made to be a comparatively large size so as to reach the end of a main body of an electronic stylus 11. As shown in FIG. 5B, the position pointing device 10 includes a main body of an electronic stylus 11 and a finger-touch-portion 53. FIG. 5A illustrates the finger-touch-portion 53 of this embodiment before it is transformed and before it is provided on the main body of the electronic stylus 11. In this embodiment, the finger-touch-portion 53 includes only a transformable portion 55. As also shown in FIG. 5A, a dummy stylus 56 is utilized. In particular, the transformable portion 55 is transformed when provided on the dummy stylus 56 and then is later removed from the dummy stylus 56 and provided on the main body of the electronic stylus 11.

In the embodiment shown in FIGS. 5A and 5B, because the transformable portion 55 is almost as long as the main body of the electronic stylus 11 and, thus, will cover the main body of the electronic stylus 11 when the two components are joined together, the user can transform not only the finger-touch-portion 53 but also almost the entire external appearance of the main body of the electronic stylus 11 as he or she desires.

Again, the transformable portion 55, which includes a shape-memory resin, may be transformed as discussed above with respect to the transformable portion 35 of the embodiment shown in FIGS. 3A and 3B.

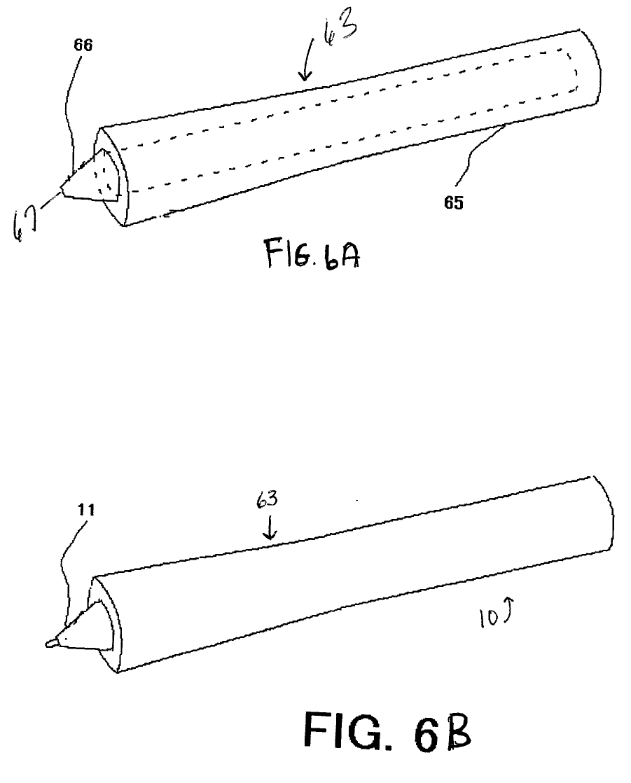

FIGS. 6A and 6B illustrate another embodiment of a position pointing device of the present invention. This embodiment is also similar to that shown in FIGS. 3A and 3B, but combines aspects of the embodiments shown in FIGS. 4A and 4B, and FIGS. 5A and 5B. In particular, in this embodiment, a tip 67 of a dummy stylus 66 is made to be pointed and a transformable portion 65 of a finger-touch-portion 63 has a length as long as a main body of an electronic stylus 11.

As shown in FIG. 6B, the position pointing device 10 includes a main body of an electronic stylus 11 and a finger-touch-portion 63. FIG. 6A illustrates the finger-touch-portion 63 of this embodiment before it is transformed and before it is provided on the main body of the electronic stylus 11. In this embodiment, the finger-touch-portion 63 includes only a transformable portion 65. As also shown in FIG. 6A, the dummy stylus 66 is utilized. In particular, the transformable portion 65 is transformed when provided on the dummy stylus 66 and then is later removed from the dummy stylus 66 and provided on the main body of the electronic stylus 11.

Again, as with the embodiments shown in FIGS. 4A and 4B, it is expected that a user can easily make the electronic stylus more comfortable to use by actually trying to write letters with a dummy stylus that has a pointed tip. Also, as with the embodiments shown in 5A and 5B, because of the length of the transformable portion 65 of the finger touch-portion 63, the user can transform not only the finger-touch-portion 63 but also almost the entire external appearance of the main body of the electronic stylus 11 as he or she desires.

And again, the transformable portion 65, which includes a shape-memory resin, may be transformed as discussed above with respect to the transformable portion 35 of the embodiment shown in FIGS. 3A and 3B.

In the above-described embodiments and examples, each of the transformable portions (the portions made of a shape-memory resin) has a substantially cylindrical shape. In certain embodiments, however, the transformable portion may have a substantially rectangular shape and the connecting portion may have a substantially ring shape.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A position pointing device comprising:
a main body of an electronic stylus including electronic components therein and shaped like an implement for writing; and
a finger-touch-portion capable of being provided on at least a portion of an outer surface of said electronic stylus, said finger-touch-portion being touchable by a user's fingers when said electronic stylus is operated and said finger-touch-portion including a shape-memory resin.

2. The position pointing device of claim 1, wherein a part equipped with said finger-touch-portion is slightly thinner compared with an outer part of said main body of said electronic stylus.

3. The position pointing device of claim 1, wherein a portion adjacent to a part equipped with said finger-touch-portion is slightly thicker compared with an outer part of said main body of said electronic stylus.

4. A position pointing device comprising:
a main body of an electronic stylus including electronic components therein and shaped like an implement for writing; and
a finger-touch-portion capable of being provided on at least a portion of an outer LAW OFFICES surface of said electronic stylus, said finger-touch-portion being touchable by a user's fingers when said electronic stylus is operated and said finger-touch-portion including an inner part that is not transformed and an outer part that is capable of being transformed; and
wherein said outer part that is capable of being transformed is made of a shape-memory resin.

5. The position pointing device of claim 4, wherein said inner part that is not transformed includes a structure for being connected with said main body of said electronic stylus.

6. The position pointing device of claim 5, wherein said structure is a connecting portion.

7. A position pointing device comprising:
a main body of an electronic stylus including electronic components therein and shaped like an implement for writing; and
a finger-touch-portion capable of being provided on at least a portion of an outer surface of said electronic stylus, said finger-touch-portion being touched by a user's fingers when said electronic stylus is operated and said finger-touch-portion including a transformable portion that is made of a shape-memory resin.

8. The position pointing device of claim 7 wherein said transformable portion has a length that is less than a length of said main body of said electronic stylus.

9. The position pointing device of claim 7 wherein said transformable portion has a length approximately as long as a length of said main body of said electronic stylus.

10. A method of customizing a shape of a position pointing device, which comprises a main body of an electronic stylus and a finger-touch-portion capable of being provided on at least a portion of an outer surface of said electronic stylus and capable of making the shape of said finger-touch-portion fit a user of said position pointing device, comprising the steps of:
providing a dummy stylus having a similar shape as a main body of an electronic stylus;
providing a finger-touch-portion on said dummy stylus, wherein said finger-touch-portion includes a transformable portion comprising a shape-memory resin;
heating said finger-touch-portion while said finger-touch-portion is provided on said dummy stylus;
holding said dummy stylus provided with said finger-touch-portion in order to transform said shape-memory resin of said transformable portion of said finger-touch-portion; and
providing said finger-touch-portion with said transformed transformable portion on said main body of said electronic stylus.

11. The method of claim 10, wherein said dummy stylus includes a pointed tip.

12. The method of claim 10, wherein said transformable portion has a length approximately as long as a length of said main body of said electronic stylus.

13. The method of claim 10, wherein said dummy stylus includes a pointed tip and said transformable portion has a length approximately as long as a length of said main body of said electronic stylus.

14. A method of customizing a shape of a position pointing device, which comprises a main body of an electronic stylus and a finger-touch-portion capable of being provided on at least a portion of an outer surface of said electronic stylus and capable of making the shape of said finger-touch-portion fit a user of said position pointing device, comprising the steps of:
providing a finger-touch-portion comprising an inner part that is not transformed and an outer part that is capable of being transformed;
heating said finger-touch-portion;
transforming said heated finger-touch-portion; and
providing said transformed finger-touch-portion on a main body of an electronic stylus.

15. The method of claim 14 wherein transforming said heated finger-touch-portion comprises a user holding said finger-touch-portion while said finger-touch portion cools.

16. A method of customizing a shape of a position pointing device, which comprises a main body of an electronic stylus and a finger-touch-portion capable of being provided on at least a portion of an outer surface of said electronic stylus and capable of making the shape of said finger-touch-portion fit a user of said position pointing device, comprising the steps of:
providing an electronic stylus having a main body;
rendering said electronic stylus waterproof in order that water will not enter inside said main body of said electronic stylus;
providing a finger-touch-portion on at least a portion of an outer surface of said main body of said electronic stylus;
heating said finger-touch-portion by putting said main body of said electronic stylus provided with said finger-touch-portion into hot water; and
transforming said heated finger-touch-portion.

17. The method of claim 16 wherein transforming said heated finger-touch-portion comprises a user holding said finger-touch-portion while said finger-touch-portion cools.
